(19) United States
(12) Patent Application Publication
(10) Pub. No.: US 2021/0157999 A1
(43) Pub. Date: May 27, 2021

(54) SHOPPING MODULE AND ROBOT HAVING THE SAME

(71) Applicant: LG ELECTRONICS INC., Seoul (KR)

(72) Inventor: Chungin JUNG, Seoul (KR)

(73) Assignee: LG ELECTRONICS INC., Seoul (KR)

(21) Appl. No.: 16/628,084

(22) PCT Filed: Jan. 2, 2019
(86) PCT No.: PCT/KR2019/000046

§ 371 Date: Jan. 2, 2020

(51) Int. Cl. G06K 7/14; H02J 7/00; B65G 1/137

(52) U.S. Cl. CPC G06K 7/1413; G06K 7/1417; B65G 1/1375; H02J 7/0042

(57) ABSTRACT

The present embodiment includes a main body having a first space formed therein; a pocket provided in the main body and having a second space smaller than the first space therein; a charging module disposed in the pocket and facing the second space; and a wireless barcode scanner of which a portion is inserted and accommodated in the pocket, wherein the wireless barcode scanner includes: a scanning module; a charging unit disposed to be activated by the charging module; and a scanner battery charged by the charging unit. A possibility of loss of the wireless barcode scanner may be minimized and inconvenience that may occur when the scanner battery is discharged may be minimized.

### TECHNICAL FIELD

The present invention relates to a shopping module and a robot having the same.

### BACKGROUND ART

Robots have been developed for industrial use to play a part in factory automation. Recently, applications of robots have increasingly been expanded and robots that may be used in daily life, as well as medical robots and aerospace robots, have also been developed.

These robots for everyday use provide specific services (e.g., shopping, serving, talking, cleaning, etc.) in response to a user's command.

However, existing robots for everyday use are designed to provide only specific services, and thus utilization of the robots against cost invested for the development of the robots is not high.

Therefore, a necessity for a robot that may provide various services has recently emerged.

### DISCLOSURE

### Technical Problem

An object of the present invention is to provide a shopping module capable of improving convenience of payment by scanning a bar code of an article, and a robot having the same.

Another object of the present invention is to provide a shopping module including a wireless barcode scanner which is charged without a separate charger, thus minimizing a possibility of loss of the wireless barcode scanner and increasing user convenience of the wireless barcode scanner, and a robot having the same.

### Technical Solution

To solve the technical problem as described above, there is provided a shopping module including: a main body having a first space formed therein; a pocket provided in the main body and having a second space smaller than the first space therein; a charging module disposed in the pocket and facing the second space; and a wireless barcode scanner of which a portion is inserted and accommodated in the pocket, wherein the wireless barcode scanner includes: a scanning module; a charging unit disposed to be activated by the charging module; and a scanner battery charged by the charging unit.

The wireless barcode scanner may include an insertion portion inserted into the pocket and a non-insertion portion exposed to the outside, the charging unit may be disposed in the insertion portion, and the scanning module may be disposed in the non-insertion portion.

The scanning module may be disposed on a surface of the non-insertion portion facing an upper side of the first space.

The wireless barcode scanner may further include a power button disposed on a front surface of the non-insertion portion.

The wireless barcode scanner may further include a scanner case having a third space in which the scanner battery is accommodated, and a communication module disposed in the scanner case.

The main body may have a through portion through which the wireless barcode scanner penetrates, and the pocket may be coupled to the main body such that the second space is positioned below the through portion.

The charging module may include a charging cable, the charging cable may include a cable and a cable terminal connected to the cable, and the main body may have a fourth space through which the cable passes.

The wireless barcode scanner may include a magnet disposed in the charging unit, and the wireless barcode scanner may be magnetically fixed to the charging cable by the magnet.

To solve the technical problem as described above, a robot having a shopping module according to an embodiment of the present invention may include a moving module having a module support plate on which the shopping module is mounted and a display unit extending upward from the module support plate. A wireless barcode scanner may be spaced apart from the display unit in a horizontal direction. When the wireless barcode scanner is inserted into a pocket, a height of a top of the wireless barcode scanner may be lower than a height of a top of the display unit.

The pocket may be disposed closer to a front end of the main body among the front end of the main body and a rear end of the main body.

The pocket may be disposed to be eccentric to one side among the left and right sides in the main body.

The non-insertion portion may be located on the left or right side of the display unit.

The wireless barcode scanner may communicate with a moving module, and the display unit may display article information of a scanned article when the article is scanned by the wireless barcode scanner.

### Advantageous Effect

According to an embodiment of the present invention, since the wireless barcode scanner may be charged while being seated by the shopping module, thereby minimizing a possibility of loss of the wireless barcode scanner and minimizing inconvenience that may occur when the scanner battery is discharged.

Further, the charging unit may be disposed in the insertion portion to be protected by the pocket, and scanning accuracy of the scanning module is high.

Further, since a consumer puts a barcode of an article to the scanning module and subsequently puts the article into a first space, ease of use of the consumer is high.

Further, in a state where the wireless barcode scanner is seated in the pocket, a consumer or a manager may easily operate the power button.

Further, the pocket may be protected by the main body and damage to the pocket by an article may be minimized.

Further, the main body may protect a charging cable.

Further, the wireless bar code scanner may be reliably connected to and maintained in a charging cable by a magnet, and arbitrary disconnection of the wireless bar code scanner may be minimized.

Further, the wireless barcode scanner may be positioned adjacent to the display unit and protected by the display unit, and the wireless barcode scanner may be spaced apart from the display unit so that a user may easily grip the wireless barcode scanner by hand if necessary.

In addition, since a scanning result of the wireless barcode scanner is displayed through the adjacent display unit, high ease of use may be achieved and high quality may be obtained.

### DESCRIPTION OF DRAWINGS

FIG. 1 is a perspective view showing a shopping module and a robot having the same according to an embodiment of the present invention;

FIG. 2 is a perspective view of the moving module shown in FIG. 1;

FIG. 3 is an exploded perspective view of the moving module shown in FIG. 2;

FIG. 4 is a cross-sectional view taken along line A-A′ shown in FIG. 1;

FIG. 5 is a front view of a robot having a shopping module according to an embodiment of the present invention;

FIG. 6 is a rear perspective view of a robot having a shopping module according to an embodiment of the present invention;

FIG. 7 is a perspective view of a shopping module according to an embodiment of the present invention;

FIG. 8 is a bottom view of a shopping module according to an embodiment of the present invention;

FIG. 9 is an exploded perspective view of a main body according to an embodiment of the present invention; and

FIG. 10 is a cross-sectional view taken along line B-B′ shown in FIG. 5.

### MODE FOR INVENTION

Hereinafter, embodiments of the present invention will be described in detail with reference to the accompanying drawings.

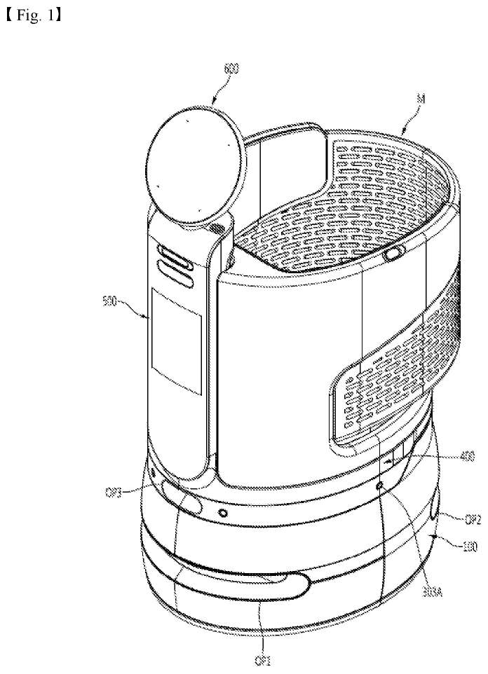

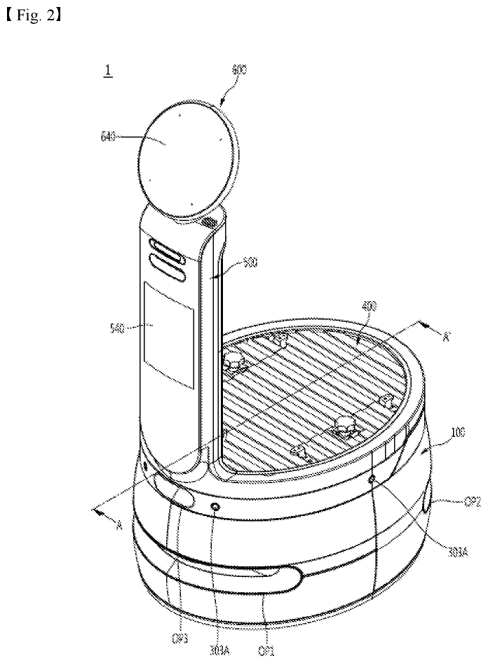

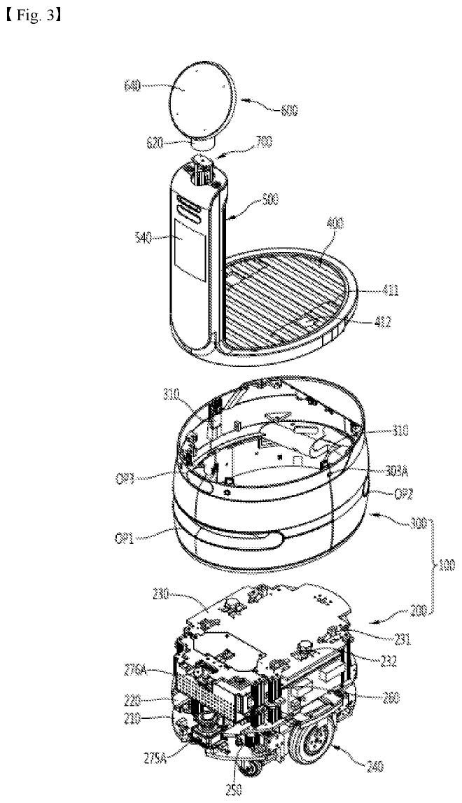

FIG. 1 is a perspective view illustrating a shopping module and a robot having the same according to an embodiment of the present invention, FIG. 2 is a perspective view of a moving module shown in FIG. 1, and FIG. 3 is an exploded perspective view of the moving module shown in FIG. 2.

A shopping module M of the present embodiment may be a service module M for providing a shopping service to a user in a shopping center such as a mart, a department store, an outlet, and the like (hereinafter, referred to as a shopping center), and the shopping module M may protect an article against falling.

An example of the shopping module M may be configured separately from a moving module 1 and may be detachably coupled to the moving module 1 so as to be used.

The shopping module M may be loaded on the moving module 1 and moved together with the moving module 1 when the moving module 1 is moved.

When the shopping module M is coupled to the moving module 1, a combination of the shopping module M and the moving module 1 may be a robot, and such a robot may be a shopping robot or a service robot that provides a transport service of articles (i.e., goods or items).

The robot may carry goods or food purchased by a customer in the shopping center instead, give directions (i.e., guide a way) to the customer, or provide unattended payment services to the customer. In addition, the robot may provide customers with the best shopping course and discount information. Such a robot is not limited to its kind and may be used in various fields as long as it is a facility capable of providing a service for carrying articles (hereinafter, referred to as a transport service).

Hereinafter, the moving module 1 will be described first and the shopping module M will be described later.

The moving module 1 may include a body 100, a traveling unit 240, a module support plate 400, display units 500 and 600, and a rotation mechanism 700.

The body 100 may constitute a body of the moving module 1.

A length of the body 100 in a front-rear direction may be longer than a width of the body 100 in a left-right direction. For example, a horizontal section of the body 100 may have a substantially elliptical shape.

The body 100 may include an inner module 200 and a housing 300 surrounding the inner module 200.

The inner module 200 may be disposed inside the housing 300. The traveling unit 240 may be provided on a lower portion of the inner module 200.

The inner module 200 may include a plurality of plates and a plurality of frames.

In more detail, the inner module 200 may include a lower plate 210, an upper plate 220 disposed above the lower plate 210, and a top plate 230 disposed above the upper plate 220. In addition, the inner module 200 may further include a plurality of lower supporting frames 250 and a plurality of upper supporting frames 260.

The lower plate 210 may constitute a bottom surface of the body 100. The lower plate 210 may be referred to as a base plate. The lower plate 210 may be horizontal. The lower plate 210 may be provided with the traveling unit 240.

The upper plate 220 may be spaced upward from the lower plate 210. The upper plate 220 may be referred to as a middle plate. The upper plate 220 may be horizontal. The upper plate 220 may be disposed between the lower plate 210 and the top plate 230 in a vertical direction.

The lower supporting frame 250 may be disposed between the lower plate 210 and the upper plate 220. The lower supporting frame 250 may extend vertically. The lower supporting frame 250 may support the upper plate 220 from a bottom of the upper plate 220.

The top plate 230 may constitute a top surface of the body 100. The top plate 230 may be spaced upward from the upper plate 220.

The upper supporting frame 260 may be disposed between the upper plate 220 and the top plate 230. The upper supporting frame 260 may extend vertically. The upper supporting frame 260 may support the top plate 230 from a bottom of the top plate 230.

The housing 300 may constitute an outer circumferential surface of the body 100. The housing 300 may be formed therein with a space in which the inner module 200 is disposed. The housing 300 may have an open top and an open bottom.

The housing 300 may surround edges of the lower plate 210, the upper plate 220, and the top plate 230. In this case, an inner circumference of the housing 300 may make contact with the edges of the lower plate 210, the upper plate 220, and the top plate 230, but the embodiment is not limited thereto.

The housing 300 may have a plurality of openings 303A. In more detail, the openings 303A may be formed in an upper portion of the housing 300. The openings 303A may be spaced apart from each other in a circumferential direction of the housing 300. An ultrasonic sensor 310 may detect an object around the moving module 1 through the openings 303A of the housing 300.

The housing 300 may include a material having a first thermal conductivity, and the inner module 200 may include a material having a second thermal conductivity which is higher than the first thermal conductivity. In more detail, at least one of the lower plate 210, the upper plate 220, the top plate 230, the lower supporting frame 250, or the upper supporting frame 260 may include a material having the second thermal conductivity which is higher than the first thermal conductivity.

For example, the housing 300 may include an injection plastic material, and at least one of the lower plate 210, the upper plate 220, the top plate 230, the lower supporting frame 250, or the upper supporting frame 260 may include a metal material such as aluminum.

Accordingly, while heat is smoothly dissipated from a heat generating component disposed on the inner module 200 through conduction, the housing 300 constitute an exterior of the body 100 may be prevented from becoming hot.

The traveling unit 240 may allow the moving module 1 to travel. The traveling unit 240 may be provided on a lower portion of the body 100. In more detail, the traveling unit 240 may be provided on the lower plate 210.

Meanwhile, the module support plate 400 may be mounted on the top surface of the body 100. The module support plate 400 preferably has a horizontal plate shape, but the embodiment is not limited thereto.

Similar to the body 100, a length of the module support plate 400 in the front-rear direction may be longer than a width of the module support plate 400 in the left-right direction.

The module support plate 400 may support the serving module M from a bottom of the serving module M. In other words, the serving module M may be seated and supported by the module support plate 400.

The serving module M may be detachably mounted on the module support plate 300.

The serving module M may be a conveyance target object conveyed by the moving module 1, and types of the serving module M are not limited. Therefore, there is an advantage that different serving modules M can be mounted on the same moving module 1 for use.

In the top surface of the body 100, that is, on the top plate 230, at least one of at least one module guide 231 configured to guide an installation position of the serving module M or at least one module fastening portion 232 fastened to the serving module M may be provided.

The module guide 231 and the module fastening portion 232 may protrude upward from the top plate 230.

The module guide 231 may pass through a sub-through-hole 411 formed in the module support plate 400, guide the installation position of the serving module M, and simultaneously prevent the serving module M from being shaken in a horizontal direction.

The module fastening portion 232 may pass through a sub-open hole 412 formed in the module support plate 400, and may be fastened to the serving module M. Therefore, the serving module M may be firmly mounted on a top of the module support plate 400.

In addition, the module guide 231 and the module fastening portion 232 may be utilized as a handle when the moving module 1 is conveyed.

The display units 500 and 600 may be disposed on an upper front side of the body 100. The display units 500 and 600 may extend vertically.

The display units 500 and 600 may include a body display unit 500 and a head display unit 600.

The body display unit 500 may be integrally formed with the module support plate 400. In this case, the body display unit 500 may extend upward from a front end of the module support plate 400. However, the body display unit 500 and the module support plate 400 may be formed as separate members.

A height of the body display unit 500 may be higher than a height of the body 100.

The body display unit 500 may include a body display 540 provided on a front surface of the body display unit 500. The body display 540 may serve as an output unit configured to display an image or a video. At the same time, the body display 540 may include a touch screen to function as an input unit configured to receive a touch input.

The body display unit 500 may be disposed on a front side of the serving module M mounted on the module support plate 400. In this case, a recess portion corresponding to a shape of the body display unit 500 may be formed in a front portion of the serving module M, and the body display unit 500 may be fitted into the recess portion. In other words, the body display unit 500 may guide a mounting position of the serving module M.

The head display unit 600 may be disposed above the body display unit 500. The head display unit 600 may be rotatably connected to an upper portion of the body display unit 500.

In more detail, the head display unit 600 may include a neck housing 620 rotatably connected to the body display unit 500. The rotation mechanism 700 may pass through an inside of the neck housing 620 to rotate the head display unit 600.

The head display unit 600 may include a head display 640 provided on the front side. The head display 600 may face a front side or an upper front side. The head display 640 may display an image or a video that describes a facial expression of a human. Accordingly, the user may receive an impression that the head display unit 600 is similar to a human head.

The head display unit 600 may rotate right and left about a vertical rotation axis within a predetermined range (e.g., 180 degrees) similarly to the human head.

The rotation mechanism 700 may rotate the head display unit 600 with respect to the body display unit 500. The rotation mechanism 700 may include a rotary motor and a rotation shaft rotated by the rotary motor. The rotary motor may be disposed inside the body display unit 500, and the rotation shaft may extend from an inside of the body display unit 500 into the neck housing 620 and may be connected to the head display unit 600.

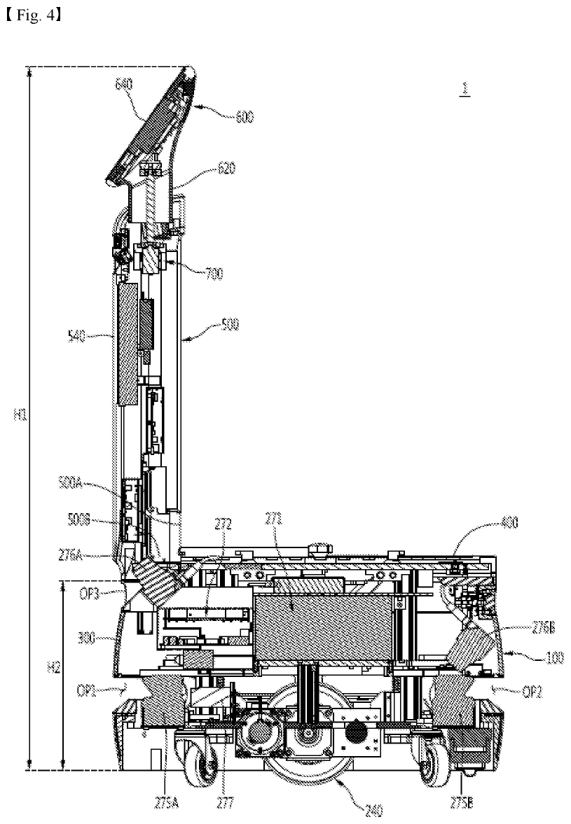

FIG. 4 is a sectional view taken along line A-A′ of FIG. 1.

A battery 271 and a control box 272 may be mounted in the body 100.

The battery 271 may store a power for operating the moving module 1.

The battery 271 may be supported by the upper plate 220 of the inner module 200. The battery 271 may be disposed between the upper plate 220 and the top plate 230.

The battery 271 may be disposed inside the body 100 while being biased rearward.

Meanwhile, the display units 500 and 600 may be supported by the top plate 230 of the inner module 200. The display units 500 and 600 may be disposed on an upper front side of the top plate 230. The body display unit 400 may not overlap the battery 271 in the vertical direction.

With the above configuration, a load of the battery 271 may be balanced with loads of the body display unit 500 and the head display unit 600. Accordingly, the moving module 1 may be prevented from tilting forward or rearward or from being overturned.

The control box 272 may be disposed on a front side of the battery 271. The control box 272 may be supported by the upper plate 220 of the inner module 200. The control box 272 may be disposed between the upper plate 220 and the top plate 230. At least a part of the control box 272 may vertically overlap the display units 500 and 600.

The control box 272 may include a boxing case having a box shape and a controller provided inside the boxing case. The boxing case may have a plurality of through-holes to dissipate heat inside the control box 272. The controller may include a PCB, and may control an overall operation of the moving module 1.

Since the control box 272 is disposed on the front side of the battery 271, the load of the battery 271 which is biased rearward may be balanced with a load of the control box 272. Accordingly, the moving module 1 may be prevented from tilting forward or rearward or from being overturned.

The body 100 may be provided with at least one radar. The lidar is a sensor capable of detecting a distance to an object and various physical properties by projecting a laser onto a target.

The body 100 may be provided with a front lidar 275A and a rear lidar 275B, and the front lidar 275A and the rear lidar 275B may detect surrounding objects, geographic features, and the like. The front lidar 275A and the rear lidar 275B may be provided at front and rear portions of the body 100, respectively.

At least a part of the front lidar 275A may be disposed under the control box 272. The front lidar 275A and the rear lidar 275B may be disposed at the same height within the body 100. The front lidar 275A and the rear lidar 275B may be disposed at a position lower than the battery 271 within the body 100.

The front lidar 275A and the rear lidar 275B may be supported by the lower plate 210 of the inner module 200. The front lidar 275A and the rear lidar 275B may be disposed between the lower plate 210 and the upper plate 220. In this case, a space inside the body 100 can be efficiently utilized as compared with a case where the front lidar 275A and the rear lidar 275B are disposed at the same height as the battery 271. Therefore, the body 100 can have a compact size.

The controller of the control box 272 may receive information detected by the front lidar 275A and the rear lidar 275B, and may perform 3D mapping based on the information or control the traveling unit 240 so that the moving module 1 may evade an obstacle.

The housing 300 may be formed at a front portion thereof with a front open portion OP1. The front open portion OP1 may be opened toward the front side. The front open portion OP1 may extend in the circumferential direction of the housing 300. The front lidar 275A may detect information on a front region of the moving module 1 through the front open portion OP1 formed in the front portion of the body 100. The front lidar 275A may detect an obstacle or the like located on a front side of the moving module 1 through the front open portion OP1 or may perform mapping on the front region of the moving module 1.

The housing 300 may be formed at a rear portion thereof with a rear open portion OP2. The rear open portion OP2 may be opened toward a rear side. The rear open portion OP2 may extend in the circumferential direction of the housing 300. The rear lidar 275B may detect information on a rear region of the moving module 1 through the rear open portion OP2 formed in the rear portion of the body 100. The rear lidar 275B may detect an obstacle or the like located on a rear side of the moving module 1 through the rear open portion OP2 or may perform the mapping on the rear region of the moving module 1.

In addition, the body 100 may be provided with at least one cliff sensor. The cliff sensor may detect a state of a ground surface and presence of a cliff through transmission and reception of infrared rays. The body 100 may be provided with a front cliff sensor 276A and a back cliff sensor 276B.

The front cliff sensor 276A and the back cliff sensor 276B may detect the state of the ground surface and the presence of the cliff on the front and rear regions of the moving module 1.

The controller of the control box 272 may receive information detected by the front cliff sensor 276A and the back cliff sensor 276B, and may control the traveling unit 240 so that the moving module 1 may evade the cliff.

The front cliff sensor 276A may be disposed above the front lidar 275A. The back cliff sensor 276B may be disposed above the rear lidar 276B.

The front cliff sensor 276A and the back cliff sensor 276B may be suspended from the top plate 230 of the inner module 200 so as to be supported by the top plate 230 of the inner module 200. The front cliff sensor 276A and the back cliff sensor 276B may be disposed between the upper plate 220 and the top plate 230.

At least a part of the front cliff sensor 276A may be disposed above the control box 272. The back cliff sensor 276B may be disposed on a rear side of the battery 271.

In other words, the front cliff sensor 276A may be disposed at a position higher than the back cliff sensor 276B within the body 100.

Accordingly, a space inside the body 100 can be effectively utilized as compared with a case where the front cliff sensor 276A is disposed on a front side of the control box 272. Therefore, the body 100 can be made in a compact size in the front-rear direction.

The housing 300 may be formed at the front portion thereof with an upper open portion OP3. The upper open portion may be formed above the front open portion OP1. The upper open portion OP3 may be opened toward the front side or a lower front side. The front cliff sensor 276A may detect the state of the ground surface on the front side of the moving module 1 through the upper open portion OP3.

The back cliff sensor 276B may detect the state of the ground surface on the rear side of the moving module 1 through the rear open portion OP2.

A wiring shutoff switch 277 may be mounted in the body 100. The wiring shutoff switch 277 may immediately stop the driving of the moving module 1 by shutting off the power of the moving module 1.

The wiring shutoff switch 277 may be disposed on a rear side of the front lidar 275A. The wiring shutoff switch 277 may be supported by the lower plate 210 of the inner module 200.

Meanwhile, a height H1 of upper ends of the display units 500 and 600 may be higher than a height H2 of an upper end of the body 100.

The display units 500 and 600 may have at least one opening through which a cable may pass.

The body display unit 500 may be formed in a rear surface thereof with a rear opening 530A. The rear opening 530A may be formed in a lower rear surface of the body display unit 500.

The body display unit 500 may be formed in a lower portion thereof with a lower opening 500B. The lower opening 500B may be formed by opening a bottom surface of the body display unit 500. The cable connected to the display unit 500 may extend into the body 100 through the lower opening 500B, and may be connected to the control box 272.

The cable connected to the serving module M may extend into the body display unit 500 through the rear opening 530A, may extend into the body 100 through the lower opening 500B, and may be connected to the control box 272.

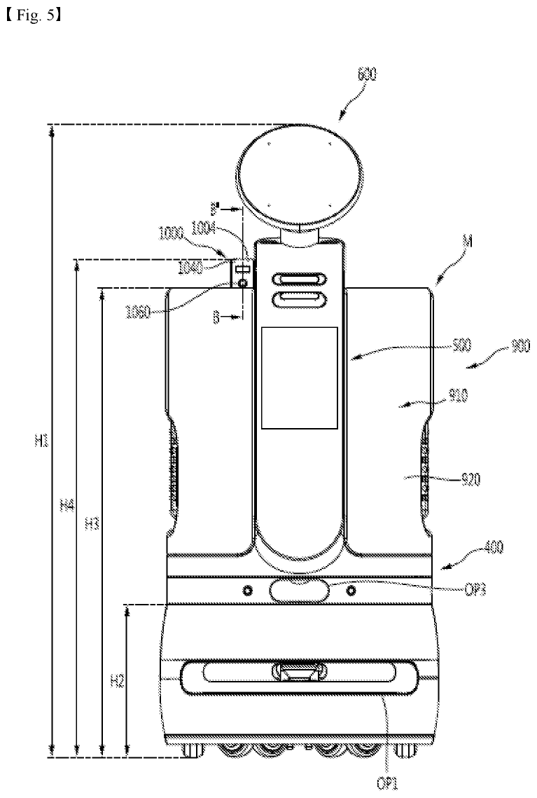

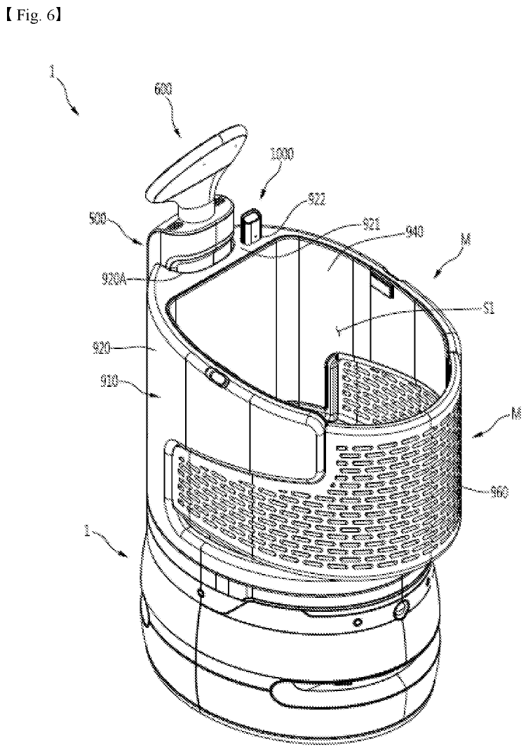

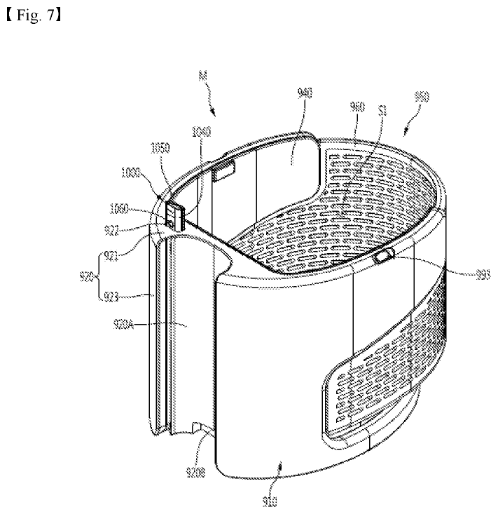

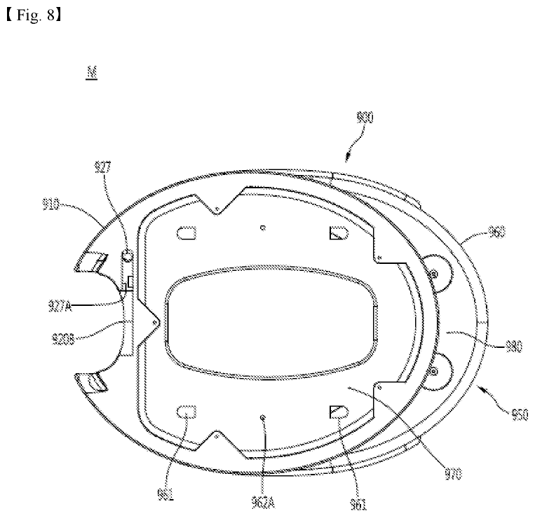

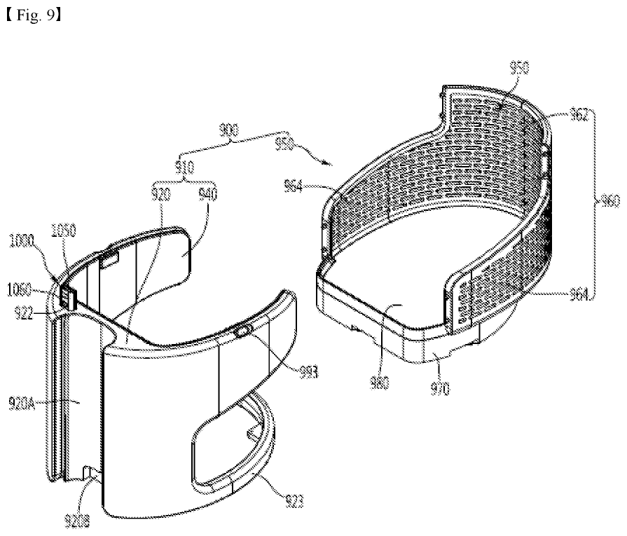

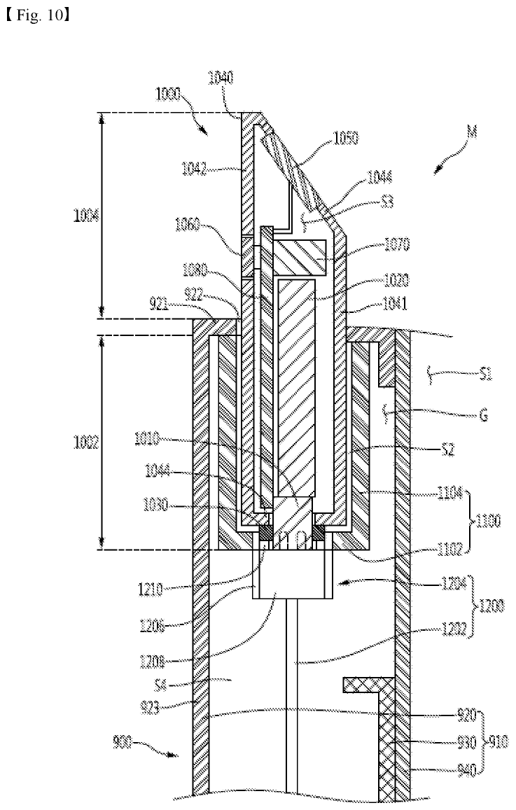

FIG. 5 is a front view of a robot having a shopping module according to an embodiment of the present invention, and FIG. 6 is a rear perspective view of a robot having a shopping module according to an embodiment of the present invention. FIG. 7 is a perspective view of a shopping module according to an embodiment of the present invention, FIG. 8 is a bottom view of a shopping module according to an embodiment of the present invention, FIG. 9 is an exploded perspective view of a main body according to an embodiment of the present invention, and FIG. 10 is a cross-sectional view taken along line B-B′ shown in FIG. 5.

The robot may include a scanner 1000. The scanner 1000 may read a predetermined type data information. For example, the scanner 1000 may read data information of at least one of a barcode and a quick response (QR) code.

The robot may be used as a cart robot used in a shopping center, an article purchaser (hereinafter, referred to as a consumer) may place a barcode provided on an article in proximity to the scanner 1000, and the barcode provided on the article may be scanned by the scanner 1000. Such a barcode may include information such as a name of the article, price information, and a country of origin, or the like (hereinafter, referred to as article information), and the robot may obtain article information through the scanner 1000.

The scanner 1000 may be a wireless barcode scanner and will be referred to as a wireless barcode scanner 1000 hereinafter.

The wireless bar code scanner 1000 may be provided in at least one of the moving module 1 and the shopping module M.

When the robot includes the moving module 1 and the shopping module M and the shopping module M is detachably coupled to the moving module 1, the wireless barcode scanner 1000 is preferably provided in the shopping module M and configures a portion of the shopping module M. Also, the wireless barcode scanner 1000 may preferably detachably seated in the shopping module so as to be easily separated from the shopping module M.

Hereinafter, the shopping module M will be described in detail.

The shopping module M may include a main body 900 having a first space S1 formed therein. The first space S1 may be a space in which an article may be accommodated. A top surface of the first space S1 may be open, and the user may easily put the article into the first space S1.

When the main body 900 is mounted on the moving module 1, a height H3 of a top of the main body 900 may be lower than a height H1 of a top of the moving module 1. The height H1 of the top of the moving module 1 may be a height H1 of a top of the display unit 500 or 600.

A front guide 920A recessed backwards may be formed on a front surface of the main body 900. The front guide 920A may be formed to extend from a top surface to a bottom surface of the main body 900. The front guide 920A may correspond to a shape of a body display unit 500. When the shopping module M is mounted on the moving module 1, at least a portion of the body display unit 500 may be inserted into the front guide 920A. Accordingly, a mounting position of the shopping module M may be guided by the body display unit 500.

A lower depression 920B may be formed at a lower portion of the front guide 920A as shown in FIGS. 7 and 8. The lower depression 920B may be formed recessed further backwards from the front guide 920A. When the shopping module M is seated on the moving module 1, the lower depression 920B may face a rear opening 500A (see FIG. 4) formed on a rear surface of the body display unit 500.

A connection recess 927A connected to the depression 920B may be formed on a bottom surface of the front portion of the main body 900. Also, the main body 900 may have a cable through hole 927 connected to the connection recess 927A. The cable through hole 927 may also be directly connected to the depression 920B. In this case, the connection recess 927A may not be provided.

A cable exiting through the rear opening 500A in the body display unit 500 may extend to the inside of the shopping module M through the connection recess 927A communicating with the lower depression 920B and a wire guide part 927.

A guide insertion portion 961 and a fastening hole 962A may be provided at a lower portion of the main body 900.

The guide insertion portion 961 may be recessed upward from the bottom surface of the main body 900.

A module guide 231 (see FIG. 3) provided on the top surface of the main body 100 of the moving module 1 may be inserted into the guide insertion portion 961. Specifically, the module guide 231 may be inserted into the guide insertion portion 961 through a sub-through hole 411 formed in the module support plate 400. Accordingly, a mounting position of the shopping module M with respect to the moving module 1 may be guided and wobbling of the shopping module M in a horizontal direction may be prevented.

The fastening hole 962A may be formed as the bottom surface of the main body 900 penetrates up and down.

The fastening hole 962A may be fastened to a module fastening portion 232 (see FIG. 3) provided on the top surface of the main body 100 of the moving module 1. Specifically, the module fastening portion 232 may pass through the sub-opening hole 412 formed in the module support plate 400 so as to be in contact with the fastening hole. In this case, a fastening member such as a screw may be fastened to the module fastening portion 232 through the fastening hole 962A. Accordingly, the shopping module M may be firmly mounted on the upper side of the moving module 1.

The shopping module M may include a simultaneous localization and mapping (SLAM) module 993 mounted on the main body 900. The SLAM module 993 may include a camera. The SLAM module 993 may be a vision sensor or an optical sensor.

The robot may perform a SLAM operation using the information detected by the SLAM module 993. That is, the traveling moving robot may measure a location thereof using the information detected by the SLAM module 993 and simultaneously create a map of a surrounding environment.

The SLAM module 993 may be installed on an upper portion of the main body 900.

A plurality of SLAM modules 993 may be provided. For example, the shopping module M may include a pair of SLAM modules 993 respectively provided on the left side and the right side of the main body 900.

The main body 900 may include a combination of a plurality of members. The main body 900 may include a front module 910 and a rear module 950.

The wireless barcode scanner 1000 may be mounted on the front module 910 and supported. The SLAM module 993 may be mounted to the front module 910. Further, the front guide 920A and the depression 920B may be formed at the front module 910.

The rear module 950 may be coupled to the front module 910 at the rear of the front module 910. The rear module 950 may form the first space S1 of the main body 900 together with the front module 910.

The rear module 640 may include a basket 960, a module base 970, and a base cover 980.

The basket 960 may include a rear basket 962 and a pair of side baskets 964 extending forward from both edges of the rear basket 962.

The rear basket 962 may form an appearance of the rear side of the shopping module M. Each side basket 964 may form an appearance of a lower portion of the side of the shopping module M.

A height of the rear basket 962 may be higher than a height of the side basket 964. Preferably, a lower end of the rear basket 962 and a lower end of the side basket 964 are continuously connected without a step.

A plurality of through holes may be formed in the basket 950. The user may easily check articles stored in the first space S1 through the plurality of through holes.

The module base 970 may be connected to the basket 960 at the lower side of the basket 960. The module base 970 may be coupled to a rear module mounting portion 923 included in the front module 910.

The guide insertion portion 961 described above may be provided in the module base 970. The guide insertion portion 961 may be formed to vertically penetrate through the module base 970. In addition, a fastening hole 962A may be provided in the module base 970.

The base cover 980 may be disposed on the module base 970. The base cover 980 may form a bottom surface of the first space S1 in which the article is accommodated.

The shopping module M may further include a pocket 1100. The pocket 1100 may accommodate a portion of the wireless scanner module 1000, in particular, a lower portion of the wireless scanner module 1000. The pocket 1100 may be provided in the main body 800. A second space S2 (see FIG. 10) smaller than the first space S1 may be provided inside the pocket 1100.

The pocket 1100 may include a lower body 1102 and an upper body 1104 extending upward from the lower body 1102 and having the second space S2 formed therein. The upper body 1104 may be hollow and may include an inner circumferential surface facing a lower portion of the wireless scanner module 1000.

As illustrated in FIG. 5, the wireless barcode scanner 1000 may be spaced apart from the display unit 500 or 600 in a horizontal direction. In addition, when the wireless barcode scanner 1000 is inserted into the pocket 1100, a height H4 of a top of the wireless barcode scanner 1000 may be higher than a height H3 of a top of the main body and may be lower than a height H1 of a top of the display unit 500 or 600.

The wireless barcode scanner 1000 may be disposed as close as possible to the display unit 500 or 600 and mounted and positioned to be closer to the front end of the main body 900 among the front end of the main body 900 and the rear end of the main body 900. To this end, the pocket 1100 may be disposed closer to the front end of the main body 900 among the front end of the main body 900 and the rear end of the main body 900.

The wireless barcode scanner 1000 may be accommodated in the pocket 1100 so as to be located on the left side or right side of the display unit 500 or 600, and the pocket 1100 may be disposed to be eccentric to one side among the left and right sides of the main body 900.

The main body 900 may protect the pocket 1100, and when the wireless barcode scanner 1000 is accommodated in the pocket 1100, the pocket 1100 may be concealed in the wireless barcode scanner 1000 and the main body 900.

A through portion 922 through which the wireless barcode scanner 1000 penetrates may be formed in the main body 900. In addition, the pocket 1100 may be coupled to the main body 900 and positioned such that the second space S2 is positioned below the through portion 922.

The through portion 922 may be a hole penetrating through a top cover 921 forming an appearance of the top surface of the main body 900 in an up-down direction.

The pocket 1100 may be coupled to the main body 900 and disposed below the top cover 921.

Meanwhile, the shopping module M may include a charging module 1200 for charging the wireless barcode scanner 1000. The charging module 1200 may be disposed in the pocket 1100 to face the second space S2.

When the wireless barcode scanner 1000 is seated inside the pocket 1100, the wireless barcode scanner 1000 may be charged by the charging module 1200, and the wireless scanner module 1000 may be charged by the shopping module M, rather than being charged by a separate charger.

The wireless barcode scanner 1000 may include a charging unit 1010 activated by the charging module 1200 and a scanner battery 1020 charged by the charging unit 1010.

Activation of the charging unit 1010 may be defined as a state in which a current flows to the charging unit 1010 by the charging module 1200 and the scanner battery 1020 is charged by the charging module 1200.

The charging module 1200, which applies power supplied from the battery 271 of the moving module 1 to the charging unit 1010, may be electrically connected to the battery 271 of the moving module 1.

The moving module 1 may include a power board that receives power from the battery 271 and distributes a voltage, such as 24V, 12V, 5V, and the like, to supply power to an electronic device that requires power. The moving module 1 may further include a junction board that receives power from the power board and supplies power to an electronic device that requires power, such as a display unit or a charging module. Such a junction board may be disposed in a control box 272 shown in FIG. 3. The charging module 1200 may be connected to the power board or the junction board via a cable and allow the scanner battery 1020 to be charged by the battery 271 of the moving module 1.

The charging unit 1010 may be disposed to face the charging module 1200 when the wireless barcode scanner 1000 is seated inside the pocket 1100. The charging unit 1010 is preferably disposed in an insertion portion 1002 of the wireless barcode scanner 1000 inserted into the pocket 1100. The charging unit 1010 may be disposed below the wireless barcode scanner 1000.

An example of the charging module 1200 may include a wireless charging module capable of wirelessly charging the wireless barcode scanner 1000. Another example of the charging module 1200 may include a charging cable connected to the wireless barcode scanner 1000.

For example, in a case where the charging module 1200 includes a wireless charging module, the charging module may include a primary coil, and the charging unit 1010 may include a secondary coil to which an induced current flows by the primary coil.

In another example, in a case where the charging module 1200 includes a charging cable, the charging module 1200 may include a cable 1202 and a cable terminal 1204 connected to the cable 1202. In this case, the charging unit 1010 may include a charging terminal connected to the cable terminal 1204.

Hereinafter, the charging unit and the charging terminal will be described using the same reference numeral. A pin may protrude from one of the cable terminal 1204 and the charging terminal 1010 and a hole, into which the pin is inserted, may be provided at the other of the cable terminal 1204 and the charging terminal 1010.

A plurality of pins may be provided in the cable terminal 1204, and the plurality of pins may be arranged in a row.

When a pin is provided in the cable terminal 1204, a plurality of holes may be provided together with the pin, and the plurality of holes may be provided in two rows in the charging terminal 1010. In this case, even if the wireless barcode scanner 1000 is inserted into the pocket 1100 such that the front and rear of the wireless barcode scanner 1000 are reversed, the charging terminal 1010 may be connected to the cable terminal 1204, and the scanner battery 1020 may be charged.

When the wireless barcode scanner 1000 is completely inserted into the pocket 1100, the charging terminal 1010 may be connected to the cable terminal 1204 as the pin is inserted into the hole, and a current flowing through the cable 1202 may flow to the charging terminal through the cable terminal 1204 and the scanner battery 1020 may be charged.

Meanwhile, the wireless barcode scanner 1000 may further include a magnet 1030 disposed in the charging unit 1010, and the wireless barcode scanner 1000 may be magnetically fixed to the charging cable by the magnet 1030.

The cable terminal 1204 may include a terminal body 1206 provided with a pin protruding therefrom, a magnetic body 1208 disposed on the terminal body 1206, and a terminal housing 1210 surrounding an outer circumference of the terminal body 1206 and the magnetic body 1208.

The magnet 1030 may be disposed to surround the outer circumference of the charging unit 1010, and when the wireless scanner module 1000 is completely inserted into the pocket 1100, the wireless scanner module 1000 may be magnetically fixed to the cable terminal 1204.

The outer circumference of the wireless barcode scanner 1000 may be formed to be slightly smaller than an inner circumference of the pocket 1100, and the wireless barcode scanner 1000 may wobble when the shopping module M moves.

As described above, when the wireless barcode scanner 1000 is magnetically fixed to the charging module 12000, wobbling of the wireless barcode scanner 1000 may be minimized and the wireless barcode scanner 1000 may be maintained in a state of being able to be continuously charged by the magnet 1030.

Meanwhile, the charging module 1200 may be formed inside the main body 900, and the main body 900 may enclose the charging module 1200 to minimize exposure of the charging module 1200 to the outside.

A fourth space S4 through which the cable 1202 penetrates may be formed in the main body 900. The fourth space S4 is a space which is different from the first space S1 and may be distinguished from the first space S1.

The main body 900 may include an outer cover 920 forming an appearance thereof and a cable guide 930 forming the fourth space S4 together with the outer cover 920. The cable guide 930 may be disposed at the rear of the outer body 920, and the space S4 in which the cable 1202 extends in a vertical direction may be formed between the outer body 920 and the cable guide 930.

The outer cover 920 may include a top cover 921 forming an appearance of the top surface of the main body 900 and a front cover 923 forming an appearance of a front surface of the main body 900.

The cable guide 930 may include a spaced portion spaced apart from the front cover 923 in a front-rear direction, and a fourth space S4 may be formed between the front cover 923 and the spaced portion.

A gap G may be formed between the cable guide 930 and the top cover 921, and a manufacturer, a repairer, or the like may access the charging cable or the pocket 1100 through the gap G.

The main body 900 may further include an inner cover 940 coupled to at least one of the outer cover 920 and the cable guide 930. When the inner cover 940 is coupled to the outer cover 920 or the cable guide 930, the gap G and the pocket 1100 may be covered and may not be visible from the outside. The inner cover 940 may cover the first space S1 and the fourth space S4 such that the first space S1 and the fourth space S4 do not communicate with each other, and the inner cover 940 may prevent damage to the charging cable.

The inner cover 940 may be spaced apart from the rear module 950 in the front-rear direction, and may form a circumferential surface of the first space S1.

The outer cover 920, the cable guide 930, and the inner cover 940 may configure the front module 910.

When the wireless barcode scanner 1000 is inserted into the pocket 1100, the wireless barcode scanner 1000 may not be entirely inserted into the second space S2 of the pocket 1100 but may be partially inserted into the pocket 1100. A length of the wireless barcode scanner 1000 in a vertical direction may be longer than a length of the second space S2 in the vertical direction.

The wireless barcode scanner 1000 may include an insertion portion 1002 to be inserted into the pocket 1010 and a non-insertion portion 1004 to be exposed to the outside.

When the wireless barcode scanner 1000 is inserted into the second space S2 of the pocket 1100, the insertion portion 1002 may be defined as a portion of the wireless barcode scanner 1000 located in the second space S1, and the non-insertion portion 1004 may be defined as a portion of the wireless barcode scanner 1000 located outside the main body 900 and the pocket 1100. When the insertion portion 1002 is accommodated in the second space S2 of the pocket 1100, the non-insertion portion 1004 may be located on the left or right side of the display unit 500 or 600.

The wireless barcode scanner 1000 may include a scanner case 1040 forming an appearance, and the scanner case 1040 may include the insertion portion 1002 and the non-insertion portion 1004.

The scanner case 1040 may have a third space S3 in which the scanner battery 1020 or a communication module 1070 may be accommodated. The scanner case 1040 may have a three-dimensional shape and may be configured as a combination of a plurality of case members. The scanner case 1040 may include a rear body 1041 forming a rear surface of the scanner case 1040 when the wireless barcode scanner 1000 is inserted into the pocket 1100, a front body 1042 located on the opposite side of the rear body 1041 and forming a front surface of the scanner case 1040, a lower body 1043 connecting a lower portion of the rear body 1041 and a lower portion of the front body 1042 and facing the charging module 1020, and an upper body 1044 connecting an upper portion of the rear body 1041 and an upper portion of the front body 1042. The wireless barcode scanner may further include a pair of side bodies.

The charging unit 1020 may be disposed in the insertion portion 1002. The charging unit 1020 may be protected by the pocket 1100 or the main body 900, without being exposed to the outside, when the wireless barcode scanner 1000 is inserted into the pocket 1100.

The wireless barcode scanner 1000 may include a scanning module 1050. The scanning module 1050 is a device for scanning a barcode of an article and may be disposed at a position where the consumer may easily put the article.

The scanning module 1050 may be disposed in the non-insertion portion 1004. The scanning module 1050 is preferably located at a position where the consumer may easily put an article to put the article into or take the article out of the space S1. The scanning module 1050 may be disposed on a surface of the non-insertion portion 1004 facing an upper side of the first space S1. In this case, the consumer may put the barcode of the article to the scanning module 1050 and subsequently put the article into the first space S1.

The scanning module 1050 may be disposed on a rear surface or a top surface of the non-insertion portion 1004. The non-insertion portion 1004 may include an inclined surface extending from the top of the rear surface of the non-insertion portion 1004 toward an upper side of the first space S1, and in this case, the scanning module 1050 may be disposed on the inclined surface and face the upper side of the first space S1. In a case where the scanner case 1040 includes an upper body 1044 having an inclined surface, the scanning module 1050 may be disposed on the upper body 1044.

The wireless barcode scanner 1000 may further include a power button 1060 allowing the user to operate the wireless barcode scanner 1000.

The wireless barcode scanner 1000 may be configured to be turned on by the consumer or a manager, and the consumer or the manager may operate the power button 1060 to switch the wireless barcode scanner 1000 to scan a barcode of an article. The power button 1060 may be disposed on the non-insertion portion 1004 so as to be operated in a state where the wireless bar code scanner 1000 is inserted in the pocket 1100. Preferably, the power button 1060 is installed at a position where the power button is not operated by the article or a part of a body of the consumer when the consumer puts the article into the first space S1. The power button 1060 may be disposed on a surface of the non-insertion portion 1004 which does not face the first space S1 or the upper side of the first space S1.

The wireless barcode scanner 1000 may include a communication module 1070 disposed in the scanner case 1040.

The wireless barcode scanner 1000 may communicate with the moving module 1 or an external device (e.g., a counter of a shopping center, a mobile terminal of the consumer, a mobile terminal of the manager, etc.), and the communication module 1070 may include a wireless communication device capable of performing wireless communication with the moving module 1 or the external device.

The communication module 1070 may be disposed in the non-insertion portion 1004.

The wireless barcode scanner 1000 may include a scanner controller 1080 controlling the wireless barcode scanner 1000. The scanner controller 1080 may be disposed inside the scanner case 1040. The scanner controller 1080 may activate the scanning module 1050 when the power button 1060 is operated. The scanner controller 1080 may control the communication module 1070 to transmit a signal through the communication module 1070.

The wireless barcode scanner 1000 may communicate with the moving module 1 through the communication module 1070, and when an article is scanned by the wireless barcode scanner 1000, the display unit 500 or 600 f the moving module 1 may display article information of the scanned article.

On the other hand, the preset is not limited to the above embodiment, it is also possible that the pocket 1100 is integrally formed on the upper portion of the main body 900, the pocket 1100 is provided in the display unit 500 or 600 and the charging module 1020 is the main body 100 or display unit 500 Of course, it can also be installed in the 600.

It will be apparent to those skilled in the art that various modifications and variations may be made in the present invention without departing from the spirit or essential characteristics thereof.

Therefore, the embodiments disclosed in the present invention are not intended to limit the technical idea of the present invention but to describe the present invention, and the scope of the technical idea of the present invention is not limited by these embodiments.

Coverage of the present invention should be construed by the following claims, and all technical ideas falling within the scope of the present invention should be construed as being included in the scope of the present invention.

1-13. (canceled)

14. A shopping module, comprising:
a main body having a first space therein;
a pocket provided in the main body, the pocket having a second space therein smaller than the first space;
a charging module disposed in the pocket and facing the second space; and
a scanner being partially insertable into the pocket, the scanner including:
a scanning module;
a charger, the charger being operable by the charging module; and
a scanner battery, the scanner battery being chargeable by the charger.

15. The shopping module of claim 14, wherein the scanner includes an insertion portion that is insertable into the pocket and a non-insertion portion that is exposed outside the main body when the insertion portion is inserted into the pocket,
wherein the charger is disposed in the insertion portion, and
wherein the scanning module is disposed in the non-insertion portion.

16. The shopping module of claim 15, wherein the scanning module is disposed on a surface of the non-insertion portion facing toward the first space.

17. The shopping module of claim 16, wherein the surface of the non-insertion portion is inclined relative to the insertion portion.

18. The shopping module of claim 15, wherein the scanner includes a power button disposed on a front surface of the non-insertion portion facing away from the first space.

19. The shopping module of claim 14, wherein the scanner includes:
a scanner case defining a third space, the scanner battery being located in the third space; and
a communicator disposed in the scanner case.

20. The shopping module of claim 14, wherein the main body has a through hole through which the scanner extends, and
wherein the pocket is coupled to the main body such that the second space is positioned below the through hole.

21. The shopping module of claim 14, wherein the charging module includes a charging cable, the charging cable including:
a cable; and
a cable terminal connected to the cable, and
wherein the main body has a cable guide through which the cable passes.

22. The shopping module of claim 21, wherein the scanner includes a magnet located at the charger, and
wherein the charging cable is magnetically fixed to the scanner by the magnet.

23. The shopping module of claim 14, wherein the scanner is a wireless barcode scanner.

24. The shopping module of claim 14, wherein the main body includes:
a front portion; and
a rear portion separably attached to the front portion,
wherein the front portion and the rear portion define the first space.

25. The shopping module of claim 14, wherein the rear portion includes:
a basket;
a base connected to the basket; and
a base cover attached to the base.

26. The shopping module of claim 25, wherein the basket includes a plurality of through holes.

27. A robot, comprising:
a shopping module, the shopping module including:
a main body having a first space formed therein;
a pocket provided in the main body, the pocket having a second space therein smaller than the first space;
a charging module disposed in the pocket and facing the second space; and
a scanner being partially insertable in the pocket, the scanner including:
a scanning module;
a charger, the charger being operable by the charging module; and
a scanner battery, the scanner battery being chargeable by the charger; and
a mover configured to transport the shopping module, the mover including:
a support plate on which the shopping module is mounted; and
a display located above the support plate,
wherein, when the scanner is inserted into the pocket, a height of a top of the scanner is lower than a height of a top of the display.

28. The robot of claim 27, wherein the pocket is disposed closer to a front end of the main body among the front end of the main body and a rear end of the main body.

29. The robot of claim 27, wherein the pocket is offset to one side among a left side and a right side of the main body.

30. The robot of claim 27, wherein the scanner includes an insertion portion that is insertable into the pocket and a non-insertion portion that is exposed outside the main body when the insertion portion is inserted into the pocket,
wherein the charger is disposed in the insertion portion, and
wherein the scanning module is disposed in the non-insertion portion.

31. The robot of claim 30, wherein the non-insertion portion of the scanner is located on a left side or a right side of the display.

32. The robot of claim 27, wherein the scanner includes:
a scanner case defining a third space, the scanner battery being located in the third space; and
a communicator disposed in the scanner case,
wherein the scanner is configured to communicate with the mover via the communicator, and
wherein the display is configured to display article information of an article when the article is scanned by the scanner.

33. The robot of claim 32, wherein the scanner is a wireless barcode scanner.
